(19) United States
(12) Patent Application Publication
(10) Pub. No.: US 2024/0127242 A1
(43) Pub. Date: Apr. 18, 2024

(54) METHODS AND SYSTEMS FOR PROCESSING CUSTOMER-INITIATED PAYMENT TRANSACTIONS

(71) Applicant: Frank Hernandez, Vessigny Village (TT)

(72) Inventor: Frank Hernandez, Vessigny Village (TT)

(21) Appl. No.: 18/351,993

(22) Filed: Jul. 13, 2023

Related U.S. Application Data
(60) Provisional application No. 63/416,724, filed on Oct. 17, 2022.

(51) Int. Cl. G06Q 20/40; G06Q 20/38

(52) U.S. Cl. CPC G06Q 20/4014; G06Q 20/382; G06Q 20/389

(57) ABSTRACT

A computer implemented method for processing customer-initiated payment transactions is disclosed. The computer implemented method is to be executed on at least one processor of a first computing device. The computer implemented method includes generating a unique identifier, derived from a second computing device's unique identifier which is associated with a first user and a first user's payment card unique identifier. Said payment card can only be associated with one computing device at a time. The method further includes recording the unique identifier on a connected database having a record keeping system. Once recorded, the method continues with the first computing device, normally in the form of an application, receiving a message to authorize a request. Lastly, the first computing device will utilize its preprogrammed logic to verify the unique identifier and authorize the request. The disclosed method eliminates personal data being shared with sellers during transactions.

### REFERENCE TO RELATED APPLICATIONS

This application claims the benefit of the filing date of U.S. Provisional Application Ser. No. 63/416,724 titled “SPECIALLY SYNCHRONIZED SYSTEM AND METHODS FOR PROCESSING CUSTOMER-INITIATED PAYMENT CARD TRANSACTIONS” and filed Oct. 17, 2022, and the subject matter of which is incorporated herein by reference.

### CROSS-REFERENCES

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISK

Not applicable.

### TECHNICAL FIELD

The present disclosure relates to the field of cybersecurity, and more specifically to the field of securing digital transactions between consumers and organizations.

### BACKGROUND OF THE INVENTION

Privacy is a fundamental right that allows individuals to maintain control over their personal information, choices, and actions. Vast amounts of sensitive information, such as personal data, financial details, and intellectual property are stored and transmitted electronically every day. Data breaches involving such information can occur and have severe consequences for individuals and organizations. Cybersecurity ensures that this information is protected from unauthorized access, theft, and misuse, safeguarding individuals and organizations from financial losses, identity theft, and reputational damage. Cybersecurity measures such as encryption, access controls, and secure data storage help to protect individuals' information from being leaked or stolen.

Current methods for securing digital transactions between consumers and organizations involve the merchant initiating the payment cycle. In this cycle, whether it is in person at a brick-and-mortar merchant, an online transaction, or at an ATM cash withdrawal site, the cardholder is required to hand over, swipe, or key-enter information from the user's card to the merchant. The opportunity for fraud is apparent in this cycle. Through various situations, a breach can come about with or without the cardholders knowledge. Fraudulent situations include losing a card or card information, stealing a card, employees of merchants copying and selling card information, skimming to counterfeit, or phishing during internet, telephone, or mail order transactions. Because this cycle is completed before the cardholder realizes, the data or money would have already been stolen, used, or transferred from the cardholders grasp to the world wide web.

As a result, there exists a need for improvements over the prior art and more particularly for a more efficient way of securing digital transactions between merchants and cardholders. The method described above having the merchant receive all information from the cardholder is very risky to the cardholder and does not work to protect the cardholder, rather opens the door to fraudsters.

### BRIEF SUMMARY OF THE INVENTION

A computer implemented method for processing customer-initiated payment transactions is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a computer implemented method for processing customer initiated payment transactions is disclosed. The computer implemented method is to be executed on at least one processor of a first computing device. The computer implemented method includes generating a unique identifier, derived from a second computing device's unique identifier which is associated with a first user and a first user's payment card unique identifier. Said payment card can only be associated with one computing device at a time. The method further includes recording the unique identifier on a connected database having a record keeping system. Once recorded, the method continues with the first computing device, normally in the form of an application, receiving a message to authorize a request. Lastly, the first computing device will utilize its preprogrammed logic to verify the unique identifier and authorize the request. The disclosed method eliminates personal data being shared with sellers during transactions and does not require input from third parties during the authentication process.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a diagram of an operating environment that supports a method for processing customer-initiated payment transactions, according to an example embodiment;

FIG. 2A is a flow chart showing the steps taken when synchronizing the second computing device with the first computing device of the computer implemented method for processing customer-initiated payment transactions, according to an example embodiment;

FIG. 2B is a diagram showing the data flow when synchronizing the second computing device and payment of the computer implemented method for processing customer-initiated payment transactions, according to example embodiments;

FIG. 3A is a flow chart showing the steps taken when synchronizing the third computing device with the first computing device of the computer implemented method for processing customer-initiated payment transactions, according to an example embodiment;

FIG. 3B is a diagram showing the data flow when synchronizing the third computing device with the first computing device of the computer implemented method for processing customer-initiated payment transactions, according to an example embodiment;

FIG. 3C is a flow chart showing the steps taken when synchronizing the fourth computing device with the first computing device of the computer implemented method for processing customer-initiated payment transactions, according to an example embodiment;

FIG. 3D is a diagram showing the data flow when synchronizing the fourth computing device with the first computing device of the computer implemented method for processing customer-initiated payment transactions, according to an example embodiment;

FIG. 4 is a flow chart showing the steps taken when the first computing device receives a message to authorize and verify the request, according to an example embodiment;

FIG. 5 is a diagram showing the data flow between all entities of the system when the first computing device receives a message to authorize a request and verify the request, according to an example embodiment;

FIG. 6A is a flow chart showing the steps taken by the first computing device when receiving a message including a pre-authorization request;

FIG. 6B is a diagram showing the data flow between all entities of the system when the first computing device receives a message to pre-authorize a request of a maximum amount of funds, according to an example embodiment;

FIG. 6C is a diagram showing the logic performed when the first computing device receives a pre-authorization request;

FIG. 7 is a diagram showing the data flow between all entities of the system when the first computing device receives a second message for remittance for a transaction amount no greater than the maximum amount, according to an example embodiment;

FIG. 8A is an illustration of a front side of a payment card, according to an example embodiment;

FIG. 8B is an illustration of a back side of a payment card, according to an example embodiment;

FIG. 9 is a diagram showing the payment card's network logic when verifying unique identifiers, according to an example embodiment; and

FIG. 10 is a block diagram of a system including an example computing device and other computing devices, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing methods and systems for processing customer-initiated payment transactions. Customer-initiated payment transactions may be generally defined as direct financial transactions initiated by the customer or account holder eliminating any card or personal data transfer to the merchant or seller. In one embodiment, these transactions may include mobile payments utilizing QR codes, contactless terminals, or PayPal. More specifically, the customer-initiated payment transactions present in the disclosed system allow a cardholder to perform a Payment Card Transaction (PCT) by using a Special Feature Card (SFC) synchronized to a Cell Phone Device (CPD). In this process, from start to finish, the user initiates and completes the transaction payment cycle without having to surrender or make known to the merchant or some other third party any of the user's payment card information. The specially synchronized card system functions with a card processing app, special feature card, Cell Phone Device, receptor acceptor device.

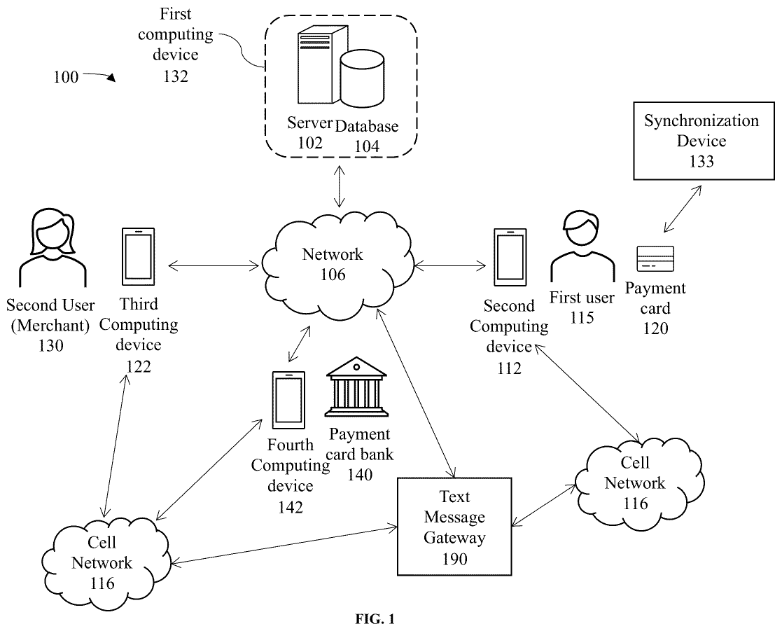

Referring now to the figures, FIG. 1 is a diagram of an operating environment 100 that supports a system for processing customer-initiated payment transactions over a communications network 106, according to an example embodiment. The environment 100 may include computing devices 112, 122, 132, 142 and servers 102, all of which may communicate with server 102 via a communications network 106. Computing devices 112, 122, 132, and 142 may include any computing devices, such as integrated circuits, printed circuit boards, processors, ASICs, PCBs, cellular telephones, smart phones, tablet computers, laptops, and game consoles, for example. Computing devices 112, 122, 132 and 142 may be connected wirelessly to the communications network 106. Communications network 106 may include one or more packet switched networks, such as the Internet, or any local area networks, wide area networks, enterprise private networks, cellular networks, phone networks, mobile communications networks, or any combination of the above. In one embodiment, computing devices 112, 122, 132, and 142 are a programmable logic controller or PLC.

Server 102 includes a software engine that delivers applications, data, program code and other information to networked devices. The software engine of server 102 may perform other processes such as transferring multimedia data in a stream of packets that are interpreted and rendered by a software application as the packets arrive. FIG. 1 further shows that server 102 includes a database 104, which may be a relational database including a Structured Query Language (SQL) database stored in a SQL server or a database that adheres to the NoSQL paradigm. Devices 112, 122, 132, and 142 may also each include databases.

Devices 112, 122, 132, and 142 and server 102 may each include program logic including computer source code, scripting language code or interpreted language code that perform various functions of the present invention. It should be noted that although FIG. 1 shows only devices 112, 122, 132, and 142 and one server 102, the system of the present invention supports any number of computing devices, servers and client computing devices connected via network 106. Also note that server 102 may be shown as a single and independent entity, in one embodiment, server 102 and its functionality may also be realized in a centralized fashion in one computer system or in a distributed fashion wherein different elements are spread across several interconnected computer systems.

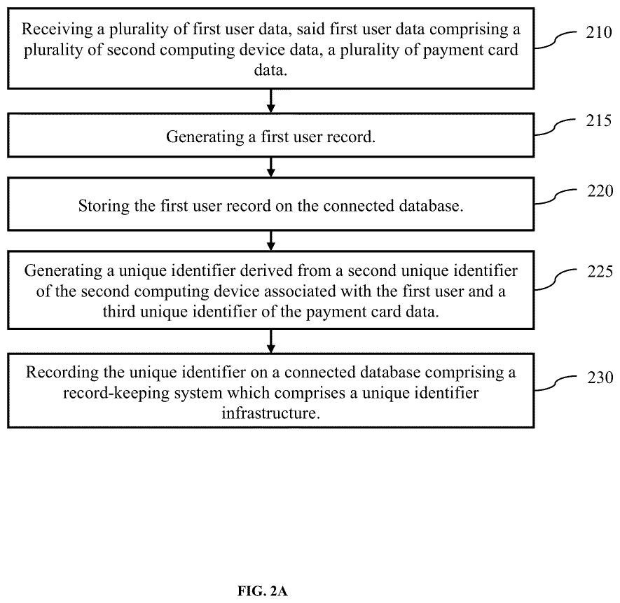

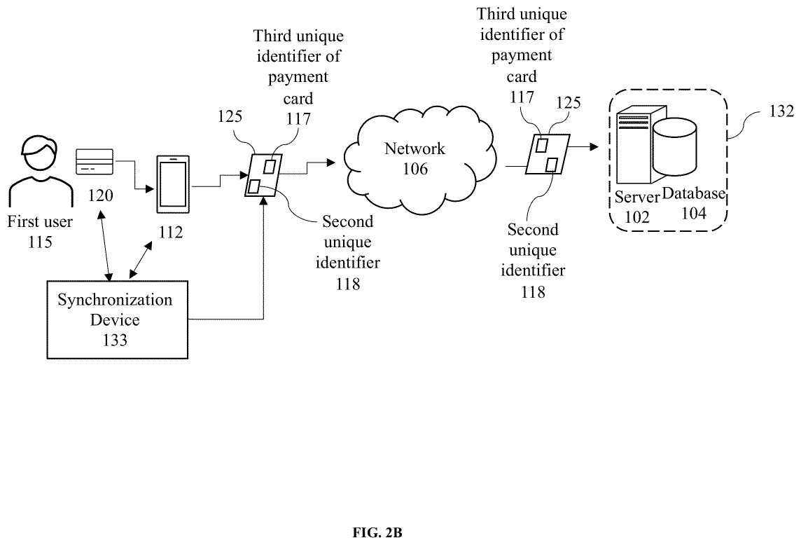

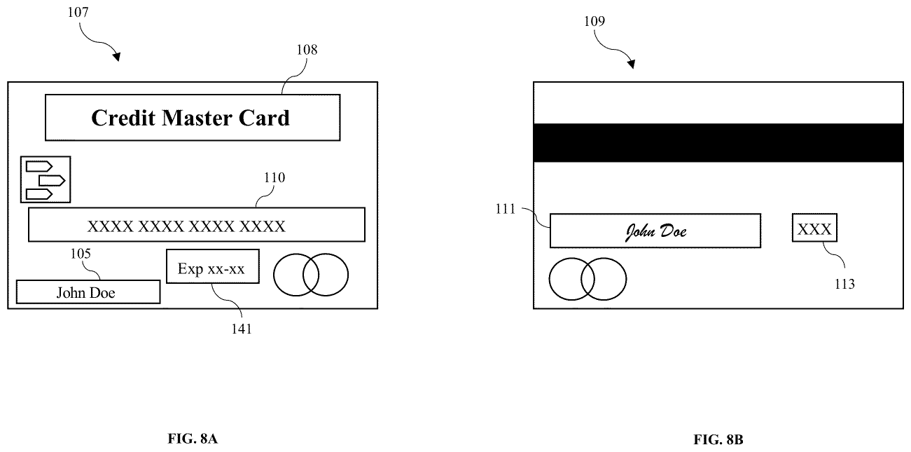

Various types of data may be stored in the database 104 of server 102. For example, the database may be configured to store user data of each user in a user record. In one embodiment, the user data may include a plurality of computing device data, a plurality of payment card data, and a user's personal identifier. This process of receiving a plurality of first user data may be referred to as step 210 of FIG. 2A. The user's personal identifier may include the users name, address, biometric data, and contact information. As shown in FIGS. 8A and 8B, the payment card front side 107 may include data such as the cardholder name 105, card number 110, expiration date 141, and bank name 108, whereas the payment card back side 109 may include data such as the cardholder signature 111, and card verification value 113. Payment card data may further include the users address, contact information, etc. The database may include rules that defining the algorithms presented below.

Additionally, each of the mobile devices is configured to be able to be moved between a locked configuration and an unlocked configuration. In an unlocked configuration, the remote computing device or mobile device allows for full normal operating mode. In full operation mode a user has access to the normal operating features to which a user would have access, such as communication functions, such as, but not limited to, e-mail and text messages, internet access, etc. In the locked configuration and operator has limited access or no access to a remote computing device or mobile device. In one embodiment, in the locked configuration, the user has no access to communication functions, such as, but not limited to, e-mail and text messages, internet access, etc. For example, in one embodiment, in the locked configuration a user may only have access to the date or time of day, instant notifications and certain applications such as a camera or QR scanner, flashlight, etc. In other embodiments, in the locked configuration a user may have access to no functions of the cellular telephone or mobile device. It is also understood that in other embodiments, the features that a user may have access to may be adjusted for both the locked and the unlocked configuration. FIG. 1 further shows a text message gateway 190, which may be a third-party entity that provides text messaging services (including both SMS and MMS messages) to server 102. The text message gateway 190 and devices 112, 122, 132, and 142 are coupled with cellular network 116 (in addition to network 106), which is a mobile phone network including a wireless communications network of transceivers. In other embodiments, the text message gateway and cellular network 116 may be included in network 106.

The first computing device 132 executes the computer implemented method on at least one or more servers 102. The second computing device 112, as mentioned above, is associated with a first user 115 having a payment card 120. The first user may be defined as the customer or person purchasing something. The first computing device 132 generates a unique identifier, as shown in step 225 of FIG. 2A, which is derived from a second unique identifier 118 of the second computing device and a third unique identifier 117 of a payment card. In an example embodiment, the unique identifier of the second computing device may be related to or derived from the device's IMEI. In other embodiment's, the unique identifier of the second computing device may be derived using methods described in more detail below. The third unique identifier of the payment card may be formed from an encoder device, the first computing device or the second computing device. The method of extracting data from the payment card and generating the payment cards unique identifier is described in detail below.

The unique identifier is shown by data packet 125 in FIG. 2B. These identifiers are used in step 230 (as shown in FIG. 2A) as the first computing device 132 synchronizes a second computing device. This process of synchronizing or registering the first user 115 computing device 112 and payment card 120 with the first computing device 132 is illustrated by FIG. 2B. It should be understood that in one embodiment, the system may include certain constraints that are implemented by the first computing device where the payment card can only be synchronized with at most one second computing device at a time. However, in other embodiments, the system may include certain constraints that are implemented by the first computing device where the second computing device of the consumer may be associated with more than one payment card. In other embodiments, the system may include certain constraints that are implemented by the first computing device such that the second computing device may be allowed to be associated with more than one payment card allowing a consumer to have multiple cards that operate on the system.

According to an example embodiment shown as FIGS. 1 and 2B, synchronization of the user's payment card 120 and mobile device 112 may involve the use of an encoder device or synchronization device 133. In some example embodiments, the encoder device may be referred to as a card terminal. In other embodiments the encoder device or synchronization device, may be a device that is used to encode onto the physical card with certain unique attributes. In operation, a user may swipe, insert, or tap a payment card on the terminal. The encoder device or synchronization device will then capture all relevant information stored on the card's magnetic strip, chip, or through wireless communication. The encoder device or synchronization device then uses encryption techniques, described in further detail below, to protect the data before being transmitted to the first computing device for storing. This encryption process is what generates the payments card's unique identifier, also referred to as the third unique identifier. This unique identifier may then be sent to the first computing device to be recorded and stored on the connected database.

In other embodiments, the encoder device or synchronization device may be incorporated in the first computing device such that a user may enter all relevant payment card information manually into the user's computing device (via a user interface on the second computing device of the user that was caused to be displayed by the first computing device) and automatically receive confirmation of a unique identifier produced and stored within the system's database. In other embodiments, the encoder device or synchronization device 133 may be used to create the unique identifier that is derived from a unique identifier of the user computing device 112 and a unique identifier of the payment card 120.

In other embodiments, the encoder device or synchronization device may use a unique identifier of the card and the user's device to create a unique identifier that is then sent to the second computing device of the user, which is then transmitted via the communications network to the first computing device.

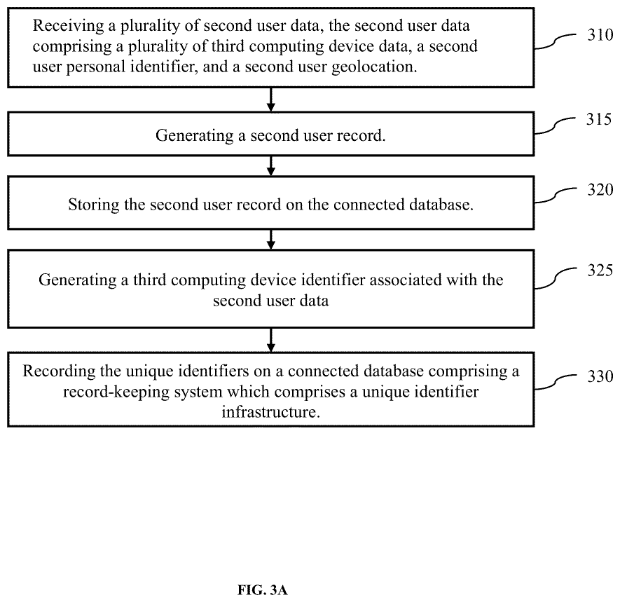

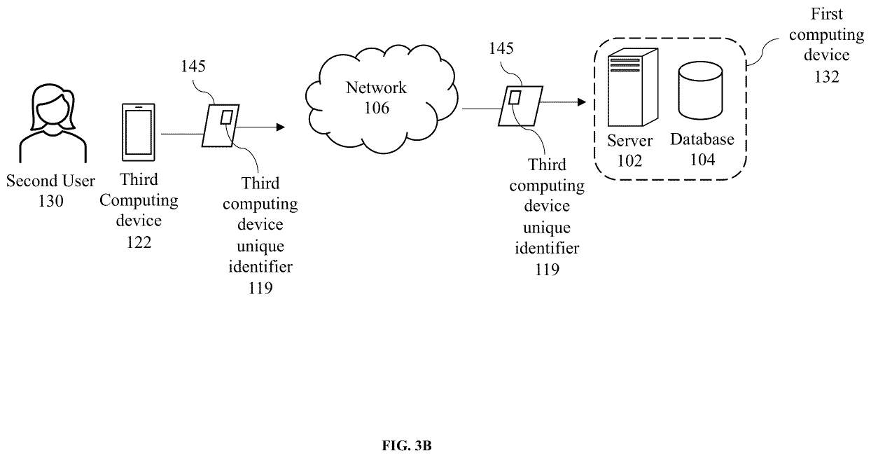

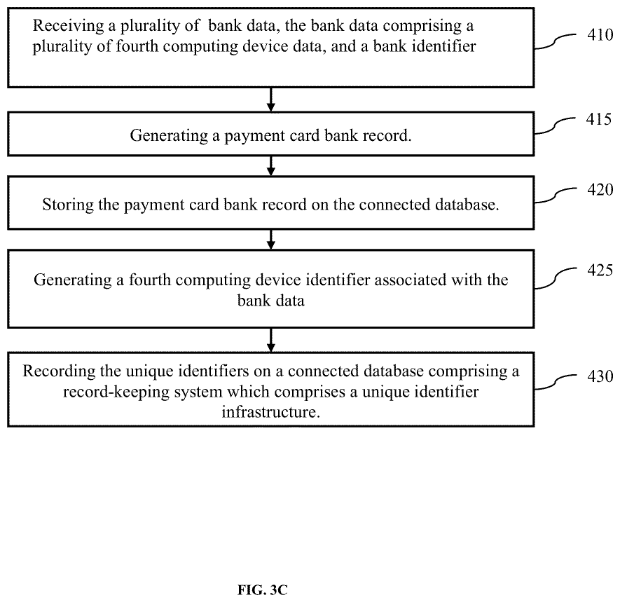

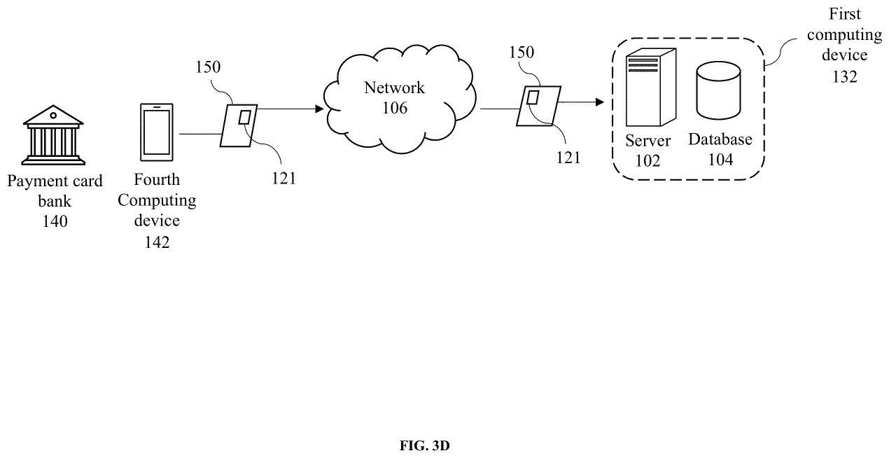

The third computing device 122 is associated with a second user 130, likely a merchant. As shown in step 310 of FIG. 3A, the first computing device 132 receives a plurality of second user data. The second user data includes a plurality of third computing device data, a second user personal identifier, and a second user geolocation. As used herein, geolocation refers to the identification or estimation of the geographical location of a device. Geolocation can be performed using various technologies and techniques such as GPS, IP geolocation, Wi-Fi and cell tower triangulation, Bluetooth, and beacon technology, etc. The third computing device data may include a third computing device identifier. The second user personal identifier data may include the second user's name, a second user's identification number, a second users address, a second user's biometric data, and a second users contact information. In one embodiment, the second user identification number may include driver's license number, social security numbers, birth date, place of birth, passport numbers, phone numbers, national insurance numbers, merchant category code (MCC), etc. The second user identification number may include a variety of personal identification data. The first computing device will then generate a second user record and third unique identifier and store the second user record and third computing device identifier in the connected database 104. This identifier is shown in step 325 (as shown in FIG. 3A) as the first computing device 132 synchronizes a third computing device. This process of synchronizing or registering the second user's computing device data with the first computing device 132 is illustrated by FIG. 3B. When synchronizing the third computing device 122 with the first computing device 132, the third computing device's unique identifier 119 is communicated through data packet 145 as shown in FIG. 3B. In some embodiments, the third computing device identifier 119 or second user identification number may be in the form of or related to the merchant category code (MCC).

The third computing device is associated with a second user 130, typically referred to as a merchant. As mentioned above, the third computing device may be in the form of a PC, smart device, or laptop. Other forms of computing devices may also be used and are within the spirit and the scope of the present invention. The third computing device unique identifier may be in the form of a distinct code or number assigned to identify and differentiate a specific merchant from others within the system. In one embodiment the merchant identifiers may include Merchant ID (MID)'s, Tax ID's or VAT numbers, national identification numbers, or business registration numbers. In another example embodiment's the third computing device's unique identifier may be related to or derived from the device's IMEI.

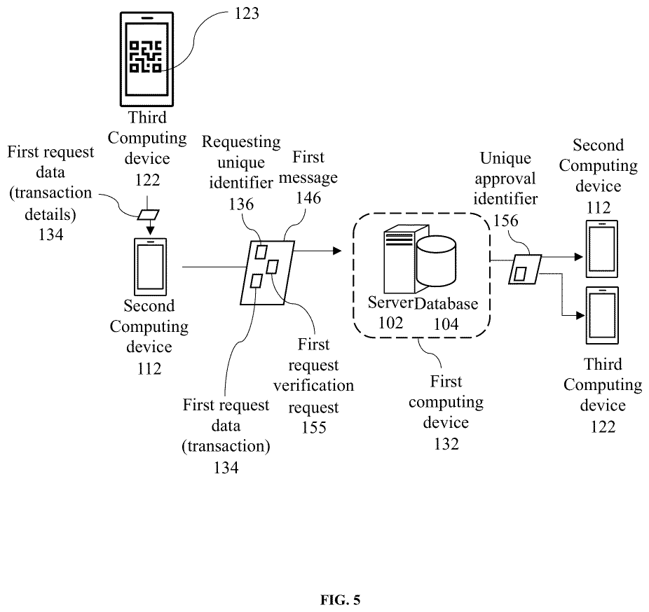

The payment card's bank, also referred to as the issuers and acquirers, are connected via the shared network and connected database of the first computing device. However, in other example embodiments, the issuer and acquirers may have separate units, devices, or processers used specifically by the payment card bank 140 handling all communications within the card networks. In such embodiments, the separate device may be referred to as a fourth computing device 142. This computing device may vary across example embodiments. In some example embodiments, the device may be in the form of a server or cluster of servers housed in highly secured data centers. Banks typically use various security measures to separate and store each user's information, therefore the fourth computing device associated with the bank may include multiple unique identifiers for each user or file as a means for ensuring security. As shown in FIG. 5, the first computing device may be used to verify the first user 115, payment card 120, and the funds held by the payment card. The first computing device 132 will receive a first message to authorize a first request depicted by data packet 146. The message includes first request data, and a requesting unique identifier, which is derived from the requesting card purporting to be the payment card identifier as well as the second computing device identifier.

FIG. 2A is a flow chart showing the steps taken when synchronizing or registering the second computing device 112 associated with the first user 115 of the computer implemented method for processing customer-initiated payment transactions. Unless otherwise stated, generally, the method described herein is not limited to the particular order of the disclosed steps. While the disclosed order provides certain improvements over the prior art, it should be understood that the method steps can be rearranged, modified, or performed in alternative sequences without departing from the scope of the disclosure. In certain embodiments, the method steps may occur concurrently, simultaneously, independently, dependently, or in any other suitable manner, as determined by the specific implementation and requirements. The flexibility of the method allows for adaptability and optimization based on various factors, such as system resources, data availability, and user preferences. Therefore, the specific arrangement and order of the method steps should be interpreted as illustrative rather than limiting, and the disclosure encompasses all variations, modifications, and alternatives falling within the scope of the appended claims.

As mentioned above, the registration begins with step 210. In step 210, the first computing device 132 will receive a plurality of first user data. The first user data is depicted as data packet 125 shown in FIG. 2B. The first user data may include a first user personal identifier, a plurality of second computing device data, and a plurality of payment card data. The first user personal identifier may include at least one of a first user name, a first user identification number, a first user address, a first user biometric data, and a first user contact information. In one embodiment, the first user identification number may include or incorporate a driver's license number, social security number, birth date, passport numbers, phone numbers, national insurance numbers, etc. The first user identification number may include a variety of personal identification data.

The second computing device 112 data may include a second computing device identifier. The payment card data may include at least one of a cardholder name 105, a card number 110, an expiration date 141, a card verification value 113, and a card holder address. An illustration of a payment card and potential payment card data is shown in FIGS. 8A and 8B. The second computing device identifier may be created by various methods including but not limited to concatenating, encrypting, hashing, salting, etc. After the first computing device has received the first user data, the method will proceed to step 215. Step 215 includes the first computing device generating a first user record. Generating the first user record may include compiling, reading, and sorting all elements received from the first user data. After the first computing device has generated the first user record, the method will continue to step 220.

Step 220 includes the first computing device storing the first user record on the connected database. The first computing device may utilize storage devices such as hard disk drives (HDDs) or solid state drives (SSDs). HDDs are mechanical storage devices that use rotating magnetic disks for data storage. SSDs use non-volatile memory chips to store data. The first computing device may utilize file systems, which provide a hierarchical structure of directories and files, to manage the first user data and first user record on the database. After the first user record is stored, the method continues to step 225.

Step 225 includes generating a unique identifier derived from a second unique identifier of the second computing device associated with the first user and a third unique identifier of the payment card data. This step ensures the customers data is kept secure within the database such that the merchant never sees or has access to the personal information. This action in the disclosed method specifically improves upon the prior art by protecting the customers data. Furthermore, during the authentication process, the system does not require any input or verification from any third party. This derivation of the unique identifier may also be described as stemming from, originating, or developed from the second and third unique identifier. This identifier may be linked or connected to the second and third unique identifiers such that the identifiers are related, include similar patterns, or incorporate certain sequences. In other embodiments, the unique identifier may be a randomized mix of the above-mentioned numbers. Deriving the unique identifier from the second unique identifier and the third unique identifier may be created by various methods including but not limited to at least one of concatenating, encrypting, hashing, salting, employing biometric feature extraction, tokenizing, obfuscating, and applying an algorithm to the second unique identifier and the third unique identifier to generate the unique identifier.

The method of concatenating refers to the process of combining two or more strings, sequences, or data elements to form a single, longer string or sequence. Concatenation is a common operation in programming and data manipulation allowing the combination of various elements or sequences to form larger, more complex entities. In relation to the present disclosure, concatenation may be used by the system in such a way that the system takes the second unique identifier string and the third unique identifier string, combines, or concatenates the two strings, and creates a new string defined as the unique identifier of the customer in the system.

The method of encryption involves using algorithms to transform a given input, such as the second or third unique identifier, into a unique and secure identifier. Additional considerations, such as incorporating randomness, unique system parameters, or combining encryption with other techniques like hashing, may be necessary to enhance uniqueness and security. In relation to the present disclosure, encryption may be used to preprocess the data (such as data formatting) from the second and third unique identifier, generate a cryptographic key to be used for transforming the readable data into ciphertext, and undergo the process of encryption creating a ciphertext consisting of seemingly random characters difficult to interpret and requiring the specific encryption key, also referred to as unique identifier, to decipher.

Hashing refers to the process of applying a hash function within software applications. Hash functions are algorithms that take an input and produce a fixed-size output known as a hash value or hash code. The purpose of these functions is to create a unique, condensed representation of the input data. In reference to the disclosed embodiment, hashing may be used by combining the second and third unique identifier values and applying a hash function. After the hash function is applied, the system will produce a unique, fixed-size output that appears random defined as the unique identifier.

The method of salting involves adding a random or unique value to the input data before performing cryptographic operations like hashing or encryption. Salting may be used to enhance security and generate unique identifiers for a given input. In reference to the disclosed embodiment, salting may be used to add uniqueness to the unique identifier. The system may add a salt, or random unique value, to the input data (second and third unique identifier) before undergoing processes such as hashing, encrypting, or concatenating. This method may help create a unique identifier to have stronger resistance to potential attacks.

Another method that may be used to generate a unique identifier is biometric feature extraction. Biometric feature extraction refers to the process of capturing and analyzing unique physical or behavioral characteristics of individuals for the purpose of identification or authentication. These biometric identifiers are used to generate unique identifiers that can uniquely represent an individual within a system or application. Tokenizing is also a process that may be used to generate the unique identifier. Tokenizing refers to the process of breaking down a given input, such as a string or text, into smaller units called tokens. Tokenization can play an important role in generating unique identifiers from the tokens extracted. Obfuscating refers to the process of intentionally obscuring of disguising the original data to create a unique representation that is difficult to reverse-engineer or guess. Obfuscating techniques aim to make the identifiers more resilient against unauthorized access or manipulation while preserving their uniqueness. The unique identifier may further be in the form of a specific code or value such as serial numbers, addresses, file hashes, etc. Once the unique identifier is generated, the method continues to step 230. Step 230 includes recording the unique identifier on a connected database which includes a record-keeping system further includes a unique identifier infrastructure.

FIG. 2B is a diagram showing the data flow when synchronizing the second computing device associated with the first user of the computer implemented method for processing customer-initiated payment transactions. Registration begins with the second computing device 112, associated with a first user 115 and payment card 120, transferring first user data through data packet 125 as mentioned above in step 210. Data packet 125 is received by the systems network 106, then sent to the first computing device 132 having server 102 and database 104 for storing the data, generating the unique identifier, and recording the unique identifier.

Synchronization of the user's payment card 120 and computing device 112 may involve the use of an encoder device or synchronization device 133. In some example embodiments, the encoder device may be referred to as a card terminal. In other embodiments the encoder device or synchronization device, may be a device that is used to encode onto the physical card with certain unique attributes. In operation, a user may swipe, insert, or tap a payment card on the terminal. The encoder device or synchronization device will then capture all relevant information stored on the card's magnetic strip, chip, or through wireless communication. The encoder device or synchronization device then uses encryption techniques, described in further detail below, to protect the data before being transmitted to the first computing device for storing. This encryption process is what generates the payments card's unique identifier, also referred to as the third unique identifier. This unique identifier may then be sent to the first computing device to be recorded and stored on the connected database.

In other embodiments, the encoder device or synchronization device may be incorporated in the first computing device such that a user may enter all relevant payment card information manually into the user's computing device and automatically receive confirmation of a unique identifier produced and stored within the system's database. In other embodiments, the encoder device or synchronization device 133 may be used to create the unique identifier that is derived from a unique identifier of the user computing device 112 and a unique identifier of the payment card 120.

In other example embodiments, the second computing device 112 may use preprogrammed logic to pull the necessary data from the device, such as the device's IMEI, in order to synchronize or encode the unique identifier in such a way that there is no need for a separate encoder or synchronization device nor a need for the first computing device to generate the said identifier. In this example embodiment, the user may scan the payment card using the camera feature on the device or may manually input the card data such that the second computing device may provide a unique identifier derived from the combination of the first user's data, the payment card data, and the second computing device data.

FIG. 3A is a flow chart showing the steps taken when synchronizing or registering the third computing device 122 associated with the second user 130 of the computer implemented method for processing customer-initiated payment transactions. Similar to the process of synchronizing the second computing device, the method begins with the first computing device 132 receiving a plurality of second user data, as shown in step 310. Similar to first user data, second user data may include a plurality of third computing device data, a second user personal identifier, and a second user geolocation. The second user personal identifier may include at least one of a second user name, a second user identification number, a second user address, a second user biometric data, and a second user contact information. In one embodiment, the second user identification number may include or incorporate a driver's license number, social security number, birth date, passport numbers, phone numbers, national insurance numbers, etc. The second user identification number may include a variety of personal identification data. The third computing device data includes a third computing device identifier. After the first computing device receives the plurality of second user data, the process continues to step 315.

Step 315 includes the first computing device generating a second user record. Generating the second user record may include compiling, reading, and sorting all elements received from the second user data. After the second user record is generated, the process continues to step 320. Step 320 includes storing the second user record on the connected database. After the record is stored, the process continues to step 325. Step 325 includes generating a third computing device identifier associated with the second user data. This third computing device identifier may be derived or stemming from, originating, or developed from the third computing device data stored. This identifier may be linked or connected to the third computing device data such that the data is related, include similar patterns, or incorporate certain sequences. In other embodiments, the unique identifier may be a randomized mix of numbers. Generating the third computing device's unique identifier may be created by various methods including but not limited to at least one of concatenating, encrypting, hashing, salting, employing biometric feature extraction, tokenizing, obfuscating, and applying an algorithm to the second unique identifier and the third unique identifier to generate the unique identifier. After the third computing device identifier is generated, the first computing device will then record the unique identifier on the connected database in step 330.

FIG. 3B is a diagram showing the data flow when synchronizing the third computing device associated with the second user of the computer implemented method for processing customer-initiated payment transactions. Similarly, to FIG. 2B, in one example embodiment, registration may begin with the third computing device 122, associated with a second user 130, transferring second user data through data packet 145 as mentioned above in step 310. Data packet 145 may then be received by the systems network 106, then sent to the first computing device 132 having server 102 and database 104 for storing the data, generating the unique identifier, and recording the unique identifier. In another embodiment, the first computing device 132 may synchronize or register all second user data and generate the third computing device's unique identifier 119. In other example embodiments, a separate encoder or synchronization device 133 may be used to receive the third computing device data, which may include the device's IMEI, and may generate the third computing device's unique identifier 119. In one example embodiment, the first computing device may send a display interface to the third computing device allowing the second user to input data required for generating the third computing device's unique identifier. The third computing device may then send the input back to the first computing device for unique identifier generation.

Generating the third computing device's unique identifier may be performed by various methods including but not limited to at least one of concatenating, encrypting, hashing, salting, employing biometric feature extraction, tokenizing, and obfuscating.

The method of concatenating refers to the process of combining two or more strings, sequences, or data elements to form a single, longer string or sequence. Concatenation is a common operation in programming and data manipulation allowing the combination of various elements or sequences to form larger, more complex entities. In relation to the present disclosure, concatenation may be used by the system in such a way that the system takes a plurality of data received such as the device's IMEI and combines or concatenates the strings to create a new string defined as the unique identifier of the merchant in the system.

The method of encryption involves using algorithms to transform a given input, such as the plurality of data received like the device's IMI, into a unique and secure identifier. Additional considerations, such as incorporating randomness, unique system parameters, or combining encryption with other techniques like hashing, may be necessary to enhance uniqueness and security. In relation to the present disclosure, encryption may be used to preprocess the data (such as data formatting) from the plurality of data received such as the device's IMEI, generate a cryptographic key to be used for transforming the readable data into ciphertext, and undergo the process of encryption creating a ciphertext consisting of seemingly random characters difficult to interpret and requiring the specific encryption key, also referred to as unique identifier, to decipher.

As mentioned above, in some example embodiments, the banks computing device, also known as the fourth computing device, may be separate from the first computing device. In such embodiments, like FIG. 3C, there are certain steps taken in order to synchronize the fourth computing device 142 associated with the payment card bank 140. According to the example embodiment, FIG. 3C, this process begins with step 410. Step 410 includes the first computing device receiving a plurality of bank data including a plurality of fourth computing device data, and a bank identifier. The bank data may include the name of the bank, the location of the bank, contact information, etc. As mentioned above, the fourth computing device 142 may be in the form of integrated circuits, printed circuit boards, processors, ASICs, PCBs, cellular telephones, smart phones, tablets, computers, laptops, etc. The bank identifier may include bank data such as address, phone number, bank name, owner name, number of accounts, number of customers, etc. Once received, the plurality of data is then organized by the first computing device and compiled generating a payment card bank record, as shown in step 415. After step 415, the method continues to step 420.

Step 420 includes storing the payment card bank record on the connected database. Once stored, the first computing device will generate a fourth computing device identifier associated with the plurality of bank data, as shown in step 425. The method then continues to step 430, recording the unique identifier on a connected database which includes a record-keeping system further includes a unique identifier infrastructure. The record keeping system may be generally defined as a structured and organized approach to capturing, storing, and managing data or information in a computer-based system. The system may involve the creation, maintenance, and retrieval of records stores within. This system helps track data effectively, facilitate informed decision-making, improve operational efficiency, and can maintain compliance with relevant regulations.

In one embodiment, each computing device may contain its own record keeping system in which data is analyzed, stored, and organized. In other embodiments, the connected database 104 may contain the record-keeping system. In another embodiment, the record-keeping system may implement a decentralized or blockchain system. A blockchain system may be described as a distributed database maintaining a list of data records. The security of a block chain may be enhanced by the distributed nature of the block chain. A block chain typically includes several nodes. Each of the nodes may be one or more computers, databases, data stores, machines, operably connect to one another. In some cases, each of the nodes or multiple nodes are maintained by different entities. A block chain typically works without a central repository or single administrator. The data records recorded in the block chain are enforced cryptographically and stored on the nodes of the block chain. In one embodiment, the unique identifier infrastructure may be described as an index of all unique identifiers stored on the connected database. In other embodiments, the unique identifier infrastructure may be defined as a public key infrastructure (“PKI”) for generating and validating digital certificates that serve as unique identifiers.

In one example embodiment, within a blockchain network, the PKI enables the generation, distribution, and verification of digital certificates and cryptographic keys. These certificates and keys play a vital role in establishing secure and authenticated communication among the various entities involved in the network. The PKI operates based on asymmetric key cryptography, utilizing public and private key pairs. Each participant within the blockchain network possesses a unique public key associated with their identity, while their corresponding private key is kept confidential. This asymmetric key pair ensures the authenticity and integrity of digital signatures and cryptographic proofs used in the blockchain network.

With the PKI, participants can digitally sign their transactions, adding an additional layer of security and verifiability to the recorded data. Digital signatures created with private keys can be verified using the corresponding public keys, ensuring that the transactions originated from the authorized parties and have not been tampered with during transmission.

Furthermore, the PKI enables secure key exchange and encryption of sensitive data within the blockchain network. By leveraging cryptographic algorithms and protocols, participants can establish secure communication channels, protect data privacy, and prevent unauthorized access. By incorporating a PKI within the blockchain network, the present disclosure ensures that the recorded transactions and interactions are performed securely, with strong authentication and protection against tampering. The PKI enhances trust and confidence in the blockchain network, promoting the veracity and integrity of the recorded data.

FIG. 3D is a diagram showing an example embodiment of the data flow when synchronizing the fourth computing device 142 that may be associated with the payment card bank of the computer implemented method for processing customer-initiated payment transactions. The fourth computing device 142, associated with the payment card bank 140 will transmit data packet 150, including a plurality of bank data 121, over the network 106. The network then sends data packet 150 to the first computing device 132 having a server 102 and a database 104. In other embodiments, the fourth computing device associated with the payment card bank may be included within the first computing device's server. In such embodiments, the registration of a fourth computing device would not be necessary.

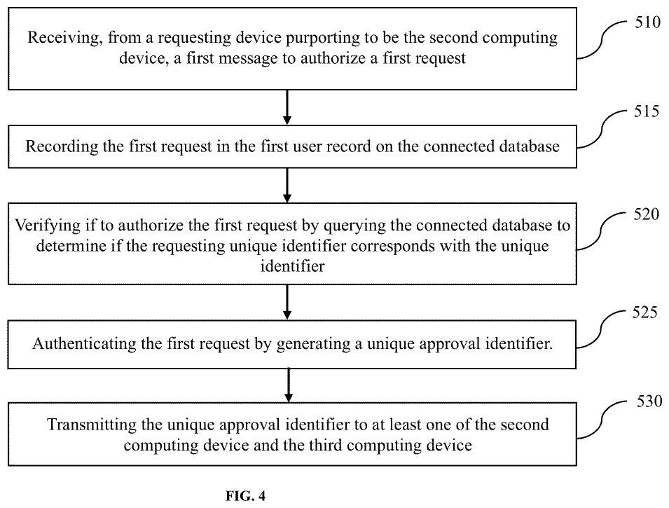

FIG. 4 is a flow chart showing the method steps when the first computing device receives a message to authorize and verify a request to determine if a transaction should be authorized. Worth noting is that at no point in the transaction is any of user information transmitted to the merchant computing device or the third computing device. The method begins with step 510. Step 510 involves the first computing device receiving, from a requesting device purporting to be the second computing device associated with the first user, a first message to authorize a first request. The first message may be referred to as data packet 146 and shown in FIG. 5. The first message may include a plurality of first request data, a requesting unique identifier derived from a requesting card purporting to be the payment card and the requesting computing device purporting to be the second computing device. The first request data may include the merchant's name, the merchant location, the merchant contact information purporting to correspond to the second user record, a transaction amount, a transaction description, and a time of transaction. Other data may also be used and is within the spirit and the scope of the present invention. After the first message is received, the method continues to step 515.

Step 515 includes recording the first request in the first user record. Once the first message is stored in the first user record, the method continues to step 520. Step 520 includes the first computing device verifying if to authorize the first request. Verification is performed by querying the connected database to determine if the requesting unique identifier corresponds with the unique identifier. As mentioned above, the unique identifier is derived from a second unique identifier of a second computing device associated with a first user and a third unique identifier of a payment card. Querying the connected database begins with the first computing device establishing a connection to the database server then formulating the query statement specifying the desired action, such as retrieving data, updating records, inserting new data, or deleting data. The query in the context of the connected database refers to a request or command that is sent to a database management system (DBMS) to retrieve or manipulate data. It is a specific instruction or question formulated using a structured query language (SQL) or a similar programming language supported by the DBMS which is then used to extract information from a database by specifying certain criteria or conditions that the data must meet. Once the query has been formed, the device sends the query to the database. Upon receiving the query, the connected database parses and analyzes the statement and performs query optimization to determine the most efficient execution plan for retrieving the data. The processor determines whether the data stored on the connected database satisfies or corresponds to the specific data request of the query. The database then executes the query, retrieves the requested data, and sends to the first computing device. A typical query consists of keywords, functions, operators, and conditions that define the desired data retrieval or manipulation operation. The query is processed by the DBMS, which searches, filters, and processes the data in accordance with the specified instructions. The result of a query is typically a subset of data that corresponds to, includes, matches the specified criteria, presented in a structured format.

Once the first computing device has queried the database, the first computing device may now determine if the requesting unique identifier corresponds to the unique identifier. The first computing device may rely on comparison operations and logical evaluations to determine if the identifiers correspond. In one embodiment, methods used for determining data correspondence may include equality comparisons such as direct data matches, string matching, data validation, machine learning and pattern recognition. In order for the requesting unique identifier to correspond to the unique identifier, the requester data must have matching data to the unique identifier. After the first request is authenticated through verification, the method continues to step 525.

Step 525 includes authenticating the first message request by generating a unique approval identifier. In reference to the present disclosure, authentication may be defined as the confirmation of receipt as well as identity confirmation. The first computing device ensures that the person and device sending the first message is registered/synchronized with the first device. In certain embodiments, authentication of a message may involve the use of cryptographic techniques, such as digital signatures or message authentication codes (MACs), to provide assurance and verification. Upon initiating first message request, the authentication server generates a unique approval identifier as a factor of authentication. This identifier is created using either a time-based algorithm or by generating a one-time code and delivering it to the user's mobile device via SMS. In some embodiments, secondary authentication may then be performed by the user's bank to ensure the funds are available. This identifier may be created using either a time-based algorithm or by generating a one-time code and delivering it to the user's mobile device via SMS. The unique approval identifier may be valid indefinitely, or, in other embodiments, may include a limited validation for a specific amount of time. For the time-based approach, the generated code changes periodically, synchronized with the user's mobile device or the authentication server. Alternatively, the SMS-based method delivers a one-time code to the user's mobile device through an established mobile communication network.

In some embodiments, the first user may decide on an amount of time in which the unique approval identifier is valid. In other embodiments, the first computing device may determine the amount of time in which the unique identifier is valid. In other further embodiments, the first user may have the option to add a timer on the code once received.

The respective user enters the received SMS code or the current time-locked code into the authentication interface or system and/or provides said code to the merchant. The unique code may be a distinct alphanumeric code or a Quick Response (QR) code that is generated and utilized to authenticate user access. This identifier serves as an additional layer of verification beyond traditional credentials and may take different forms depending on the implementation.

For alphanumeric codes, the unique approval identifier is typically a randomly generated string of characters that may include letters, numbers, and special symbols. It is used to uniquely identify and validate the authentication process.

In the case of a QR code, the unique approval identifier takes the form of a machinereadable matrix barcode. The QR code may contain encoded information specific to processing the transaction while ensuring the protection of any personally identifiable information (PII). The QR code contains encoded data essential for transaction processing, such as payment amount, transaction description, and currency details. It ensures a secure and efficient authentication process without compromising sensitive PII. The QR code's purpose is to provide a unique and time-sensitive element to the authentication process, enhancing security while protecting the privacy of user information. The QR code is scanned or processed by an authentication system to validate and authorize user access securely.

Both alphanumeric codes and QR codes provide a unique and time-sensitive element to the authentication process, enhancing security and minimizing the risk of unauthorized access or processing of a transaction. The authentication server verifies the correctness and validity of the provided code by comparing it with the expected value. If the code matches the expected value and falls within the valid timeframe, the authentication is confirmed, granting the user access to the requested processing of the transaction. The utilization of a unique approval identifier, whether delivered via SMS or generated through time-based algorithms, enhances security by introducing an additional layer of authentication beyond traditional credentials. The system ensures reliable delivery and validation of the identifier, providing a robust and user-friendly authentication experience.

This step improves over the prior art by eliminating any personal data from being transferred from the customer to the merchant. The data the merchant receives is the unique approval identifier which may be in the form of a QR code. Once the first computing device generates the unique approval identifier, the method continues to step 530. The generation of a QR code as a factor of authentication improves upon prior art by effectively conveying only relevant information required to execute a transaction while safeguarding against the transfer of PII data. This approach addresses the limitations of traditional authentication methods that may involve sharing sensitive PII during the authentication process.

By encoding essential transaction details, such as payment amount, transaction description, and currency information, within the QR code, the authentication system can verify and authorize the transaction without exposing sensitive PII. This significantly reduces the risk of unauthorized access or potential misuse of personal data. Compared to alternative methods that might involve manual input of PII data, such as account numbers or identification details, generating a QR code for authentication enhances security and privacy. The QR code acts as a secure token, containing only the necessary information to process the transaction, thereby limiting exposure of sensitive data. Moreover, the use of QR codes simplifies and expedites the authentication process for users. The users can conveniently scan the QR code using a mobile device or compatible scanner, eliminating the need for manual entry of PII and reducing the potential for human error.

Step 530 includes transmitting the unique approval identifier to at least of either the second computing device or the third computing device. During registration, the first user may decide whether they prefer the unique approval identifier should be sent to the second computing device, allowing the customer to show the merchant, or the third computing device, allowing the merchant to be sent to identifier directly. The unique approval identifier may be in the form of an alphanumeric code, a barcode, QR code, etc. In some embodiments as mentioned above, the merchant may have the unique approval identifier sent directly to the third computing device to complete the transaction. In other embodiments, the first user may receive the unique approval identifier and show or send the approval code to the merchant. This method of having a code presented to a merchant rather than a credit card or any account or personal information improves upon the problems with the prior art and provides a level of security protecting the customer from potential fraud.

FIG. 5 is a diagram showing the data flow between all entities of the system. In one embodiment, for example, the merchant may input or automatically scan information related to a transaction into the third computing device. The third computing device may then have a type of display code 123 presented on the display of the third computing device. The code may be an alphanumeric code, QR code, mark, tag, etc. that the user may capture or input with the second computing device 112 of the consumer. In other example embodiments, the merchant may manually input the transaction details into the third computing device via a user interface on the third user computing device that was caused to be generated by the first computing device. The third computing device may then generate a display code in one of the forms described above. In other embodiments, the second user or merchant may scan a barcode on an item providing the transaction details to the third computing device then allowing the third computing device to generate a display code 123. In some example embodiments, computing device may generate a code by using specialized algorithms and libraries that can encode data into a QR code or other code format. Code 123 or what is displayed on the third computing device will next be scanned, input, or captured by the second user computing device. This may be done using the second user device camera, or by manually inputting the information into an interface provided on the second user computing device.

Once the second computing device receives the first request data 134, the second computing device will send a first message (depicted as data packet 146) including the requesting unique identifier 136, first request data (transaction) 134 and first request verification request 155 to the first computing device or system to authorize a request and verify the request. As referred to in step 510, the first user, being a customer, associated with the second computing device will first send a message to the first computing device of the system. This message is illustrated as data packet 146. The first request includes a request for payment of funds. After the first computing device receives the request, the first computing device will verify that the request identifier, derived from a user identifier and a second computing device identifier, corresponds to the third unique identifier, being the payment card or bank account identifier. In some embodiments, once verified, a first request verification request 155 will be transmitted further to a fourth computing device associated with the bank of the payment card in order to ensure funds are available for said purchase. In other embodiments, the fourth computing device may be included in the first computing device. Once the fourth computing device or first computing device approves the first request verification request, a unique approval identifier 156 will be transmitted to either the second computing device associated with the first user, being the customer, or the third computing device associated with the second user, being the merchant. However, it is understood that the fourth computing device associated with the payment processing system may be incorporated into the first user computing device.

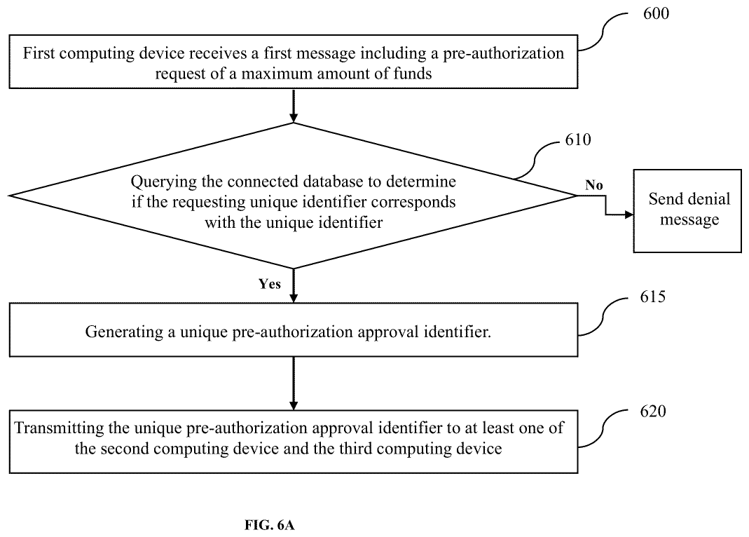

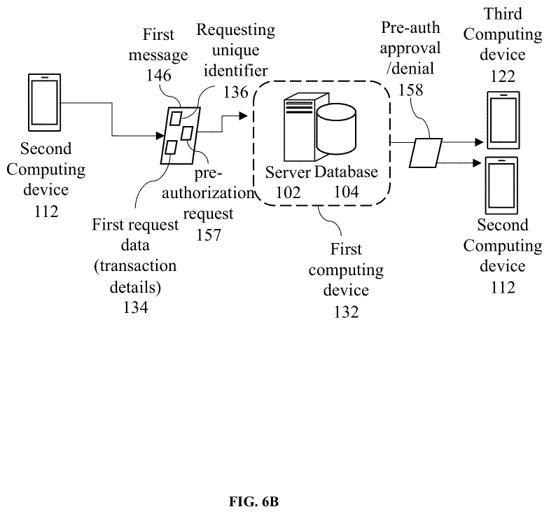

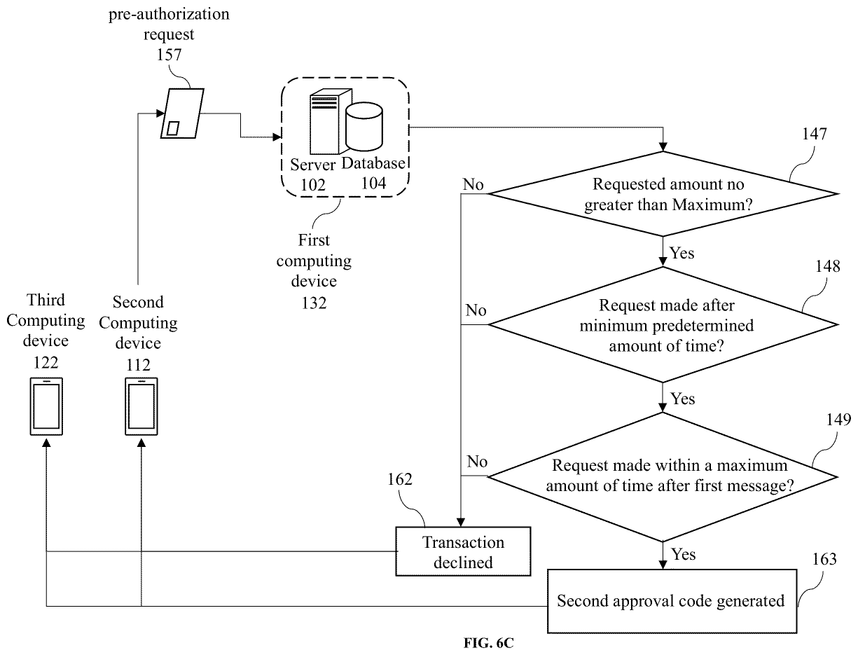

In some embodiments, the first request may include a pre-authorization request. FIG. 6B is a diagram showing the data flow between all entities of the system when the first computing device receives a message to pre-authorize a request of a maximum amount of funds. FIG. 6A shows the steps taken by the system when receiving a pre-authorization request (step 600). Pre-authorization may be generally defined as a process where a certain amount of funds is temporarily reserved or blocked on a customer's account or credit card before the actual transaction takes place. Pre-authorization may help the merchant mitigate the risk of accepting payments that may later prove to be insufficient or fraudulent. For example, many vehicle rental companies will pre-authorize transactions to ensure the customer has sufficient funds to cover potential charges like rental fees, fuel, or any damages that may occur during the rental period. The computer implemented method disclosed herein allows the user to send a message from the second computing device 112 requesting pre-authorization of a transaction.

This first request is depicted in FIG. 6B as first message depicted by data packet 146. In some embodiments, the first request includes a pre-authorization request 157 of a maximum amount of funds. As shown in FIG. 6C, the pre-authorization request 157 is then transmitted to the first computing device. The first computing device then checks all data associated with the request including the amount as shown in step 147. If the amount of funds requested exceeds the maximum amount of funds available, then the system will move to step 161 sending a “transaction declined” message 162 to second or third computing device. If the funds are available, the system will continue to step 148.

Next, in step 148, the time of the request will be compared to the minimum predetermined amount of time allowed. If the time of the request is made after the minimum predetermined amount of time, then the system will continue to step 149. On the other hand, if the request is made before the minimum predetermined amount of time is reached, the system will move to step 161 and send a “transaction declined” message 162 to the second or third computing device.

Next, in step 149, the system will determine if the time of the request has been made within the maximum amount of time allowed. If the time of the request has been made within the maximum amount of time allowed, then the system will continue to step 161 to generate and send a second approval code 163 to the second or third computing device. On the other hand, if the time of the request has not been made within the maximum amount of time allowed, the system will move to step 161 and send a “transaction declined” message 162 to the second or third computing device.

In some embodiments, the pre-authorization request is also transmitted to the banking device 142 associated with the payment card bank. Referring back to FIG. 6A, once the system verifies, as shown in step 610, and approves the request, the system will continue to step 615. Step 615 includes the first computing device generating a preauthorization approval identifier. After the per-authorization approval identifier is generated, the system will move to step 620. In step 620, the system will transmit the unique approval identifier including the pre-authorization request approval or denial 158 for the maximum amount of funds after a minimum predetermined amount of time to the first computing device 132.

Generally, “a pre-authorization request approval or denial for the maximum amount of funds after a minimum predetermined amount of time” refers to a specific process in which a financial transaction is pre-approved for the highest possible amount of funds, but the actual transfer or charge occurs only after a specified minimum duration has elapsed. In this context, the term “pre-authorization request” signifies a preliminary request to reserve or confirm the availability of funds for a transaction. The approval or denial of this request indicates that the requested amount, typically the maximum allowed, is set aside, or held in anticipation of the actual transaction. The phrase further emphasizes that the preauthorization approval becomes effective only after a minimum predetermined time has passed. This time delay serves as a precautionary measure, allowing for any potential changes or adjustments before the actual transfer or charge takes place. It provides a grace period during which the transaction can be modified or canceled if needed.

In some embodiments, the minimum predetermined amount of time may be decided by the first user. For example, if a first user were to plan a large purchase such as a home or a car, they may want the pre-authorization request approval to be valid at the time of the purchase and no sooner. In this scenario, the first user may assign the minimum predetermined amount of time to be, for example, two weeks in the future. In other embodiments, the first user may choose the minimum predetermined amount of time to be ten seconds such that the user may complete the transaction as soon as possible. Furthermore, in other embodiments, the minimum predetermined amount of time may be automatically applied once the pre-authorization request approval is sent to the first computing device. The maximum amount of funds may be defined as the purchase amount. In other example embodiments, the maximum amount of funds may be a larger value than the transaction amount. For example, when renting a vehicle, the lender may request the rental amount plus an additional buffer to cover any potential damage. In other embodiments, the maximum amount may be the exact transaction amount. The predetermined amount of time may vary across different embodiments.

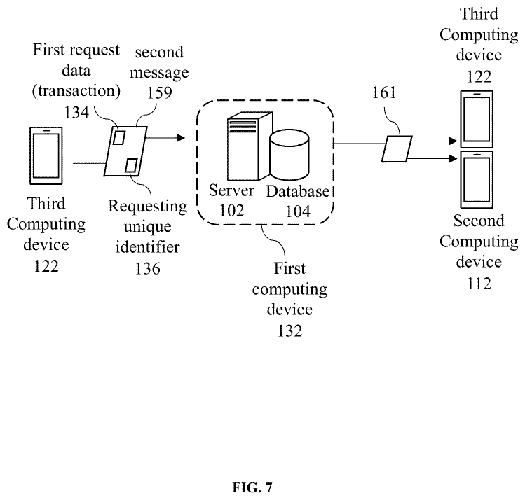

FIG. 7 is a diagram showing the data flow between all entities of the system when the first computing device receives a second message 159 for remittance for a transaction amount no greater than the maximum amount of funds approved. As mentioned above, an example of a maximum amount of funds may be referred to when renting a vehicle, such that the lender may request the rental amount plus an additional buffer to cover any potential damage. Generally, the maximum amount of funds refers to the highest permissible or approved limit for the transfer or remittance of money in a given transaction. It represents the maximum monetary value that is authorized or allowed for the specific transaction under consideration. The term “maximum amount of funds” indicates a predefined limit that has been set and approved by the relevant entities or systems involved in the transaction and signifies the upper bound or cap on the monetary value that can be transferred or remitted.

In the specific context of the present disclosure, the flow of data between the entities of the system occurs when the first computing device receives a second message related to remittance. This second message specifies a transaction amount, which is expected to be equal to or less than the “maximum amount of funds” that has been previously approved or authorized for that particular transaction. Essentially, the “maximum amount of funds” serves as a restriction or boundary that ensures that the transaction remains within the predefined financial limit, providing control and security measures for the transfer or remittance process.

If the first computing device receives a second message 159 for remittance for a transaction amount of no greater than the maximum amount of funds from the third computing device after a minimum of predetermined time, within a maximum of predetermined amount of time, and having the unique approval identifier, then the first computing device will transmit to the third computing device and/or second computing device, a second approval 163, as shown in step 161, or denial, as shown in step 162, of the transaction amount.

FIGS. 8A and 8B are illustrations of a front side 107 of a payment card, and a back side 109 of a payment card, according to an example embodiment. As mentioned above, the payment card may include data such as the cardholder's name 105, a card number 110, an expiration date 141, a card verification value 113, a cardholder signature 111, and the bank name 108. In other embodiments, the payment card data may include a bank identification number or BIN. Other cards of forms of payment may also be used as are within the spirit and the scope of the present invention.

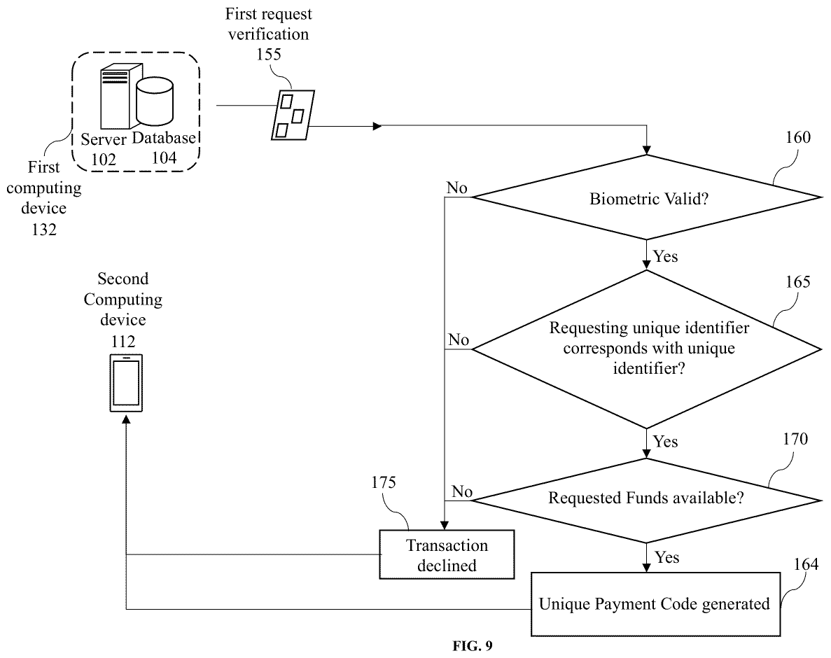

FIG. 9 is a diagram showing the payment card's network logic when verifying unique identifiers. As shown in the present example embodiment, as the first computing device receives the first request verification request, the first computing device will begin using its preprogrammed logic to determine if the request is to be authorized or declined. The order of the logic steps may differ in other embodiments or may include additional steps. In the example embodiment, the first computing device first starts with step 160. In step 160 the first computing device first determines if the biometric data stored on the first user record matches the unique identifier given to the first user and second computing device by the first computing device system. If the biometric data matches, the first computing device will continue to step 165. On the other hand, if the biometric data stored on the first user record does not match the unique identifier given to the first user and second computing device by the first computing device system then the first computing device will move to step 175 where the first computing device will transmit a “transaction declined” message to the second computing device.

Next, in step 165, the first computing device determines if the requesting unique identifier corresponds with the unique identifier derived from the payment card and second user computing device. If the unique identifier corresponds to one another device and/or card, the first computing device will continue to step 170. On the other hand, if the requesting unique identifier does not correspond with the unique identifier derived from the payment card and the second user computing device, then the first computing device will move to step 175 where the first computing device will transmit a “transaction declined” message to the second computing device.

Next, in step 170, the first computing device will determine if the requested funds are available in the bank account associated with the payment card. If the funds are available, the first computing device will conclude its verification process and move to step 161 transmitting a message approving the transaction 164 and providing the second computing device with a unique approval identifier. On the other hand, if the requested funds are not available in the bank account associated with the payment card, then the first computing device will proceed to step 175 transmitting a “transaction declined” message.

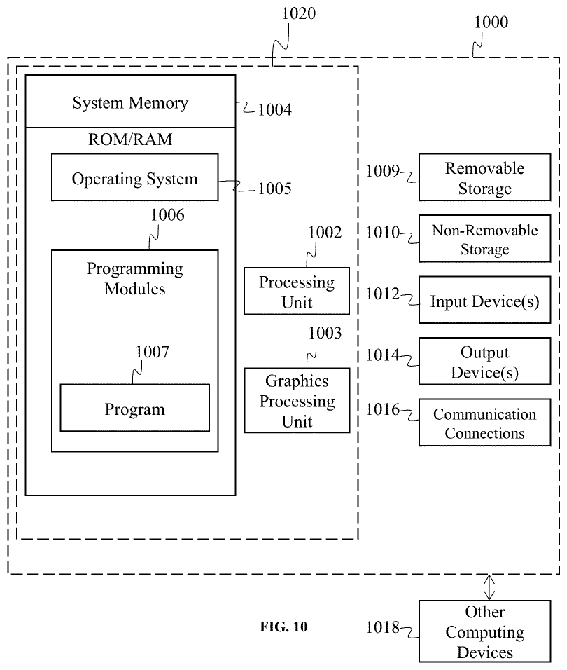

FIG. 10 is a block diagram of a system including an example computing device 1000 and other computing devices. Consistent with the embodiments described herein, the aforementioned actions performed by devices 112, 122, 132, and 142 may be implemented in a computing device, such as the computing device 1000 of FIG. 10. Any suitable combination of hardware, software, or firmware may be used to implement the computing device 1000. The aforementioned system, device, and processors are examples and other systems, devices, and processors may include the aforementioned computing device. Further-more, computing device 1000 may include an operating environment for the methods shown in FIGS. 2A, 3A, 3C, and 4 above.

With reference to FIG. 10, a system consistent with an embodiment of the invention may include a plurality of computing devices, such as computing device 1000. In a basic configuration, computing device 1000 may include at least one processing unit 1002 and a system memory 1004. Depending on the configuration and type of computing device, system memory 1004 may include but is not limited to, volatile (e.g., random access memory (RAM)), nonvolatile (e.g., read-only memory (ROM)), flash memory, or any combination or memory. System memory 1004 may include operating system 1005, one or more programming modules 1006 (such as program module 1007). Operating system 1005, for example, may be suitable for controlling computing device 1000's operation. In one embodiment, programming modules 1006 may include, for example, a program module 1007. Furthermore, embodiments of the invention may be practiced in conjunction with a graphics library, other operating systems, or any other application program and is not limited to any particular application or system. This basic configuration is illustrated in FIG. 10 by those components within a dashed line 1020.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a nonremovable storage 1010. Computer storage media may include volatile and nonvolatile, removable, and non-removable media implemented in any method or technology for storage of information, such as computer readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable readonly memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 1000. Any such computer storage media may be part of device 1000. Computing device 1000 may also have input device(s) 1012 such as a keyboard, a mouse, a pen, a sound input device, a camera, a touch input device, etc. Output device(s) 1014 such as a display, speakers, a printer, etc. may also be included. The aforementioned devices are only examples, and other devices may be added or substituted.

Computing device 1000 may also contain a communication connection 1016 that may allow device 1000 to communicate with other computing devices 1018, such as over a network in a distributed computing environment, for example, an intranet or the Internet.

Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acous-tic, radio frequency (RF), infrared, and other wireless media. The term computer readable media as used herein may include both computer storage media and communication media.

As stated above, a number of program modules and data files may be stored in system memory 1004, including operating system 1005. While executing on processing unit 1002, programming modules 1006 may perform processes including, for example, one or more of the methods shown above. Computing device 1000 may also include a graphics processing unit 1003, which supplements the processing capabilities of processing unit 1002 and which may execute programming modules 1006, including all or a portion of those processes and methods shown above. The aforementioned processes are examples, and processing units 1002, 1003 may perform other processes. Other program-ming modules that may be used in accordance with embodi-ments of the present invention may include electronic mail and contacts applications, word processing applications, spreadsheet applications, database applications, slide presentation applications, drawing or computer aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configura-tions, including handheld devices, multiprocessor systems, microprocessor based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be prac-ticed in an electrical circuit including discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments of the inven-tion. The functions/acts noted in the blocks may occur out of the order as shown in any flowchart. For example, two blocks shown in succession may in fact be executed substantially concurrently or the blocks may sometimes be executed in the reverse order, depending upon the function-ality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer implemented method for processing customer-initiated payment transactions, the computer implemented method to be executed on at least one or more processors of a first computing device, the computer implemented method comprising:
generating a unique identifier derived from a second unique identifier of a second computing device associated with a first user and a third unique identifier of a payment card, wherein the second unique identifier is an International Mobile Equipment Identity (IMEI) of the second computing device, and the third unique identifier is a unique identifier of the payment card;
wherein the payment card can only be associated with at most one second computing device at a time;
recording the unique identifier on a connected database comprising a record-keeping system which comprises a unique identifier infrastructure;
receiving, from a requesting computing device purporting to be the second computing device, a first message to authorize a first request, wherein the first message includes (i) a plurality of first request data of the first request, (ii) a requesting unique identifier derived from a requesting card purporting to be the payment card and the requesting computing device purporting to be the second computing device;
wherein, the requesting unique identifier is generated from a unique identifier of the requesting computing device and a unique identifier of a requesting card purporting to be the payment card, wherein the unique identifier of the requesting computing device is an International Mobile Equipment Identity (IMEI) of the requesting computing device;
verifying if to authorize the first request by querying the connected database to determine if the requesting unique identifier corresponds with the unique identifier; and
generating and transmitting a unique approval identifier to at least one of the second computing device and a third computing device when the first request is approved.

2. The computer implemented method of claim 1, wherein prior to generating the unique identifier, the computer implemented method comprises:
receiving a plurality of first user data, said plurality of first user data comprising a plurality of second computing device data, a plurality of payment card data, and a first user personal identifier; generating a first user record; and storing the first user record on the connected database.

3. The computer implemented method of claim 2, wherein the first user personal identifier comprises at least one of: a first user name, a first user identification number, a first user address, first user biometric data, and a first user contact information.

4. The computer implemented method of claim 3, wherein said plurality of second computing device data comprises a second computing device identifier.

5. The computer implemented method of claim 2, wherein said plurality of payment card data comprises at least one of a cardholder name, a card number, an expiration date, a card verification value, and a cardholder address.

6. The computer implemented method of claim 5 further comprising:
receiving a plurality of second user data, the plurality of second user data comprising a plurality of third computing device data, a second user personal identifier, and a second user geolocation; and
generating a second user record; and storing the second user record on the connected database.

7. The computer implemented method of claim 6 wherein the second user personal identifier comprises at least one of a second user name, a second user identification number, a second user address, second user biometric data, and a second user contact information.

8. The computer implemented method of claim 6, wherein the plurality of third computing device data comprises a third computing device identifier.

9. The computer implemented method of claim 8, wherein the plurality of first request data comprises a merchant name, a merchant location, a merchant contact information purporting to correspond to the second user record, and wherein the plurality of first request data further comprises an amount of transaction, a transaction description, and a time of transaction.

10. The computer implemented method of claim 9 further comprising recording the first request in the first user record.

11. The computer implemented method of claim 10, wherein if the first request is approved in said verification, then the method further comprises authenticating the first request by generating a unique approval identifier.

12. The computer implemented method of claim 11 further comprising transmitting the unique approval identifier to at least one of the second computing device and the third computing device.

13. The computer implemented method of claim 12 further comprising processing the first request such that first user data is not transmitted to the third computing device.

14. The computer implemented method of claim 13 wherein deriving the unique identifier from the second unique identifier and the third unique identifier comprises at least one of concatenating, encrypting, hashing, salting, employing biometric feature extraction, tokenizing, obfuscating, and applying an algorithm to the second unique identifier and the third unique identifier to generate the unique identifier.

15. The computer implemented method of claim 11, wherein the first request comprises a pre-authorization request of a maximum amount of funds;
wherein the unique approval identifier comprises an approval of the pre-authorization request for the maximum amount of funds after a minimum predetermined amount of time;
wherein if a second message for remittance for a transaction amount for no greater than said maximum amount of funds is received from the third computing device (i) after the minimum predetermined amount of time (ii) within a maximum predetermined amount of time after the first message and (iii) comprising the unique approval identifier, then transmitting to at least one of the third computing device and second computing device a second approval of the transaction amount.

16. The computer implemented method of claim 12, wherein the first request comprises a request for payment of funds;
wherein the unique approval identifier comprises an approval of the request for payment of funds.

17. A computer implemented method for processing customer-initiated payment transactions, the computer implemented method to be executed on at least one or more processors of a first computing device, the computer implemented method comprising:
generating a unique identifier derived from a second unique identifier of a second computing device associated with a first user and a third unique identifier of a payment card, wherein the second unique identifier is an International Mobile Equipment Identity (IMEI) of the second computing device, and the third unique identifier is a unique identifier of the payment card;
recording the unique identifier on a connected database comprising a record-keeping system which comprises a unique identifier infrastructure;
generating a requesting unique identifier from a unique identifier of a requesting computing device and a unique identifier of a requesting card purporting to be the payment card, wherein the unique identifier of the requesting computing device is an International Mobile Equipment Identity (IMEI) of the requesting computing device;
receiving, from a requesting device purporting to be the second computing device, a first message to authorize a first request, wherein the first message includes (i) a plurality of a first request data of the first request, (ii) the requesting unique identifier derived from a requesting card purporting to be the payment card and the requesting computing device purporting to be the second computing device;
verifying if to authorize the first request by querying the connected database to determine if the requesting unique identifier corresponds with the unique identifier; and
generating and transmitting a unique approval identifier to at least one of the second computing device and a third computing device when the first request is approved.

18. The computer implemented method of claim 17, further comprising:
receiving a plurality of first user data, said plurality of first user data comprising a plurality of second computing device data, a plurality of payment card data, and a first user personal identifier; wherein the first user personal identifier comprises at least one of: a first user name, a first user identification number, a first user address, first user biometric data, and a first user contact information; and wherein the plurality of payment card data comprises at least one of a cardholder name, a card number, an expiration date, a card verification value, and a cardholder address;
wherein the plurality of second computing device data comprises a second computing device identifier;
generating a first user record and storing the first user record on the connected database;
receiving a plurality of second user data, the plurality of second user data comprising a plurality of third computing device data, a second user personal identifier, and a second user geolocation;
wherein the second user personal identifier comprises at least one of a second user name, a second user identification number, a second user address, second user biometric data, and a second user contact information; wherein the plurality of third computing device data comprises a third computing device identifier; and
generating a second user record and storing the second user record on the connected database.

19. The computer implemented method of claim 17, wherein the first request comprises at least one of (i) a pre-authorization request of a maximum amount of funds and (ii) a request for payment of funds;
wherein the computer implemented method further comprises authenticating the first request by generating a unique approval identifier, and processing the first request such that first user data is not transmitted to the third computing device.

20. A computer implemented method for processing customer-initiated payment transactions, the computer implemented method to be executed on at least one or more processors of a first computing device, the computer implemented method comprising:
generating a unique identifier derived from a second unique identifier of a second computing device associated with a first user and a third unique identifier of a bank account associated with the first user, wherein the second unique identifier is an International Mobile Equipment Identity (IMEI) of the second computing device, and the third unique identifier is a unique identifier of a payment card;
recording the unique identifier on a connected database comprising a record-keeping system which comprises a unique identifier infrastructure;
receiving, from a requesting device purporting to be the second computing device, a first message to authorize a first request, wherein the first message includes a plurality of a first request data of the first request;
wherein, a requesting unique identifier is generated from a unique identifier of a requesting computing device and a unique identifier of a requesting card purporting to be the payment card, wherein the unique identifier of the requesting computing device is an International Mobile Equipment Identity (IEI) of the requesting computing device;
verifying if to authorize the first request by querying the connected database to determine if the requesting unique identifier corresponds with the unique identifier; and
generating and transmitting a unique approval identifier to at least one of the second computing device and a third computing device when the first request is approved.
